(19) United States
(12) Patent Application Publication
(10) Pub. No.: US 2014/0133553 A1
(43) Pub. Date: May 15, 2014

(54) APPARATUS, METHOD, AND PROGRAM FOR CODING IMAGE AND APPARATUS, METHOD, AND PROGRAM FOR DECODING IMAGE

(71) Applicant: Masato Shima, Tokyo (JP)

(72) Inventor: Masato Shima, Tokyo (JP)

(73) Assignee: CANON KABUSHIKI KAISHA, Tokyo (JP)

(21) Appl. No.: 14/232,214

(22) PCT Filed: Jul. 11, 2012
(86) PCT No.: PCT/JP2012/004469

§ 371 Date: Jan. 10, 2014

(30) Foreign Application Priority Data
Jul. 13, 2011 (JP) 2011-155011
Apr. 27, 2012 (JP) 2012-103806

(51) Int. Cl. H04N 19/126; H04N 19/50

(52) U.S. Cl. CPC H04N 19/00096; H04N 19/00569
USPC 375/240.03

(57) ABSTRACT

An image processing apparatus of the present invention has the following configuration:

An image coding apparatus includes an image partitioning unit configured to partition an input image into a plurality of blocks; a prediction unit configured to perform a prediction on the partitioned blocks from a coded block to create a prediction error; a transform unit configured to determine an orthogonal transform method from a plurality of orthogonal transform methods and to perform the determined orthogonal transform on the created prediction error to create a transform coefficient; a quantization-matrix selecting unit configured to select a quantization matrix on the basis of the determined orthogonal transform method; a quantization unit configured to quantize the transform coefficient created by the transform unit by using the quantization matrix selected by the quantization-matrix selecting unit to create a quantization coefficient; and a coefficient coding unit configured to code the quantization coefficient quantized by the quantization unit.

### TECHNICAL FIELD

The present invention relates to an apparatus, method, and program for coding an image, and an apparatus, method, and program for decoding an image, and in particular, to a quantization method and methods for coding and decoding a quantization matrix.

### BACKGROUND ART

A known example of video compression formats include H.264/MPEG-4 AVC (hereinafter referred to as H.264). (ITU-T H.264 (March 2010) Advanced video coding for generic audiovisual services) H.264 can change the individual elements of a quantization matrix to any values by coding scaling_list information. According to NPL 1, the individual elements of a quantization matrix can take any values by adding a difference value, delta_scale, to the immediately preceding elements.

The activity to develop an international standard of higher-efficiency coding scheme as a successor to H.264 has recently been started. Joint collaborative team on video coding (JCT-VC) was developed between the ISO/IEC and the ITU-T and is standardizing as high-efficiency video coding (HEVC) scheme (hereinafter referred to as HEVC).

To improve the coding efficiency, an orthogonal transform method, such as a discrete sine transform, is under study in addition to the conventional orthogonal transform method using discrete cosine transform. FIGS. 2A and 2B show examples of transform matrices used in the orthogonal transform. Reference numerals 200 and 201 denote transform matrices, in which they have a 4*4 pixel configuration for ease of explanation, and in which the individual squares in the thick frames represent the coefficients in the transform matrix. Reference numeral 201 denotes an example of transform matrices used in a conventional discrete cosine transform. Reference numeral 202 denotes an example of transform matrices used in a discrete sine transform. In orthogonal transforms using these transform matrices, multiplications of the transform matrices denoted by numerals 200 and 201 and coefficient matrices to be transformed are first performed, respectively. The products are then multiplied by the transposed matrices of the transform matrices denoted by 200 and 201, and thereafter, the coefficients are normalized to achieve orthogonal transforms. Hereinafter a multiplication of a transform matrix and a coefficient matrix to be transformed is referred to as a horizontal transform, and a multiplication of the product and the transposed matrix of the transform matrix is referred to as a vertical transform. Coding is performed using such a plurality of orthogonal transform methods in this way (Working Draft, JCT-VC, JCTVC-E603.doc, the Internet [http://phenix.int-evry.fr/jct/doc_end_user/documents/5_Geneva/wg11/)

Also for the HEVC, the introduction of a system for setting the elements of a quantization matrix to any values is under consideration, as in H.264. Furthermore, the HEVC uses a plurality of orthogonal transform methods. The distribution of coefficients as the result of the orthogonal transforms depends on the orthogonal transform methods. Therefore, if the orthogonal transform and the quantization matrix do not match, proper quantization is not performed, thus causing significant degradation in image quality.

### CITATION LIST

### Non Patent Literature

NPL 1: Advanced video coding for generic audiovisual services, ITU-T H.264 (March 2010)

### SUMMARY OF INVENTION

The present invention is made to solve the above problems. Accordingly, the present invention provides a method for properly using a quantization matrix depending on the orthogonal transform method. The present invention can reduce the amount of codes when setting a quantization matrix for each orthogonal transform.

An image processing apparatus according to the present invention has the following configuration:

An image coding apparatus includes an image partitioning unit configured to partition an input image into a plurality of blocks; a prediction unit configured to perform a prediction on the blocks partitioned by the image partitioning unit from a coded block to create a prediction error; a transform unit configured to determine an orthogonal transform method from a plurality of orthogonal transform methods and to perform the determined orthogonal transform on the prediction error created by the prediction unit to create a transform coefficient; a quantization-matrix selecting unit configured to select a quantization matrix on the basis of the orthogonal transform method determined by the transform unit; a quantization unit configured to quantize the transform coefficient created by the transform unit by using the quantization matrix selected by the quantization-matrix selecting unit to create a quantization coefficient; and a coefficient coding unit configured to code the quantization coefficient quantized by the quantization unit.

The present invention allows quantization matrices to be set for individual orthogonal transform methods, thus allowing optimum quantizing processes to be performed using the individual orthogonal transform methods.

Further features of the present invention will become apparent from the following description of exemplary embodiments with reference to the attached drawings.

### BRIEF DESCRIPTION OF DRAWINGS

FIG. 1 is a block diagram showing the configuration of an image coding apparatus of a first embodiment of the present invention.

FIG. 2A is a diagram showing an example of a transform matrix.

FIG. 2B is a diagram showing an example of a transform matrix.

FIG. 3 is a block diagram showing the configuration of an image decoding apparatus according to a second embodiment of the present invention.

FIG. 4 is a diagram showing examples of a quantization matrix.

FIG. 5 is a flowchart of the image coding process of the image coding apparatus according to the first embodiment.

FIG. 6 is a flowchart of the image decoding process of the image decoding apparatus according to the second embodiment.

FIG. 7A is a diagram showing an example of the configuration of a bit stream.

FIG. 7B is a diagram showing an example of the configuration of a bit stream.

FIG. 8 is a block diagram showing the configuration of an image coding apparatus of a third embodiment of the present invention.

FIG. 9 is a block diagram showing the configuration of an image decoding apparatus of a fourth embodiment of the present invention.

FIG. 10 is a flowchart of the image coding process of the image coding apparatus according to the third embodiment.

FIG. 11 is a flowchart of the image decoding process of the image decoding apparatus according to the fourth embodiment.

FIG. 12 is a block diagram showing an example of the configuration of computer hardware that can be applied to the image coding apparatus and the image decoding apparatuses according to the above embodiments.

FIG. 13A is a diagram showing an example of a two-dimensional quantization matrix.

FIG. 13B is a diagram showing an example of a two-dimensional quantization matrix.

FIG. 13C is a diagram showing an example of a two-dimensional quantization matrix.

FIG. 13D is a diagram showing an example of a two-dimensional quantization matrix.

FIG. 14 is a flowchart of the image coding process of an image coding apparatus according to a fifth embodiment of the present invention.

FIG. 15 is a flowchart of the image decoding process of an image decoding apparatus according to a sixth embodiment of the present invention.

### DESCRIPTION OF EMBODIMENTS

### First Embodiment

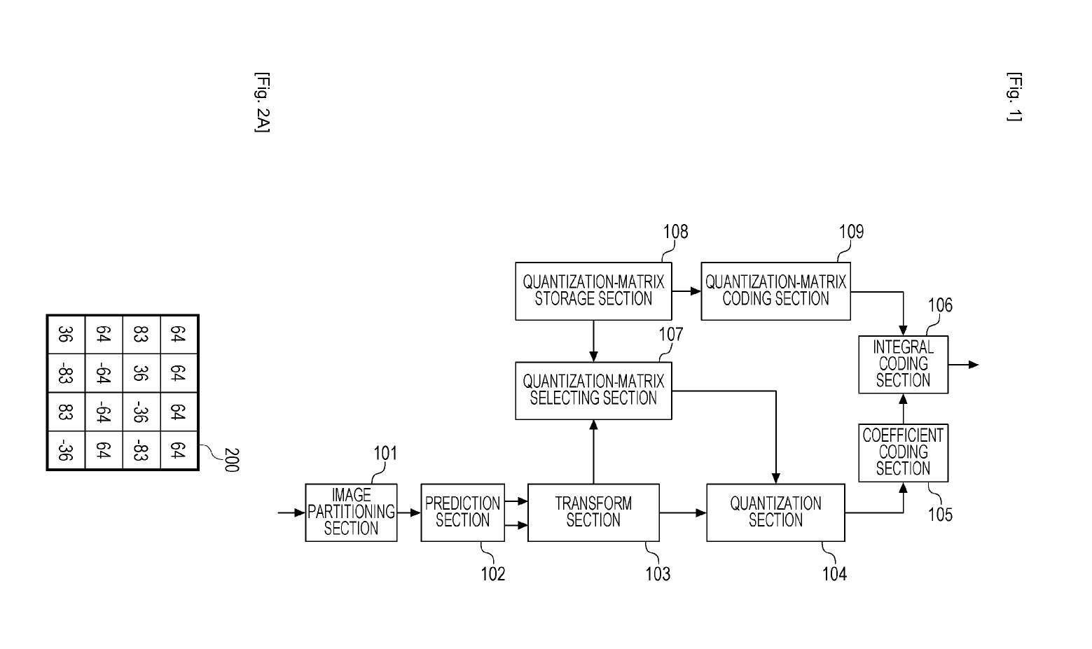

Embodiments of the present invention will be described hereinbelow with reference to the drawings. FIG. 1 is a block diagram of an image coding apparatus of a first embodiment of the present invention.

In FIG. 1, reference numeral 101 denotes an image partitioning section that partitions an input image into a plurality of blocks. Although this embodiment is described on the assumption that the image partitioning section 101 partitions an image into 8*8 pixel blocks for ease of explanation, the present invention is not limited thereto.

Reference numeral 102 denotes a prediction section that performs a prediction on the blocks partitioned by the image partitioning section 101 from coded blocks, determines prediction methods, calculates difference values in accordance with the methods, and calculates prediction errors. For an intra-coded frame of a still image or a movie, intra-prediction is performed, and motion compensation prediction is also performed for the movie. The intra-prediction is generally implemented by selecting a method of referring to a reference pixel for calculating a prediction value from data of the surrounding pixels for each of a plurality of reference methods.

Reference numeral 108 denotes a quantization-matrix storage section that creates quantization matrices and temporarily stores them. A method for creating the quantization matrix to be stored is not particularly limited; it is needless to say that the quantization matrices may be input by the user, may be calculated from the characteristics of the input image, or may be one that is designated in advance as an initial value.

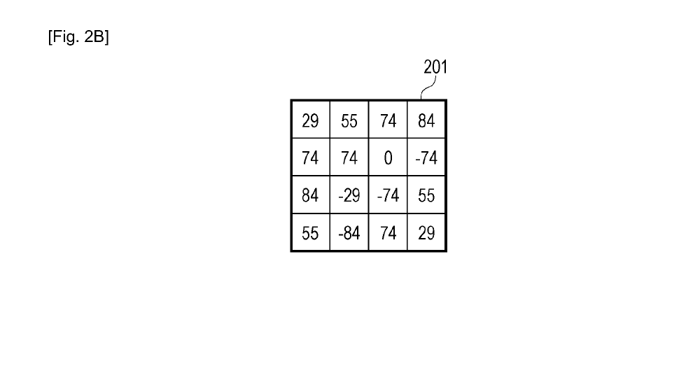

Reference numeral 103 denotes a transform section that determines orthogonal transform methods on the basis of the prediction methods for the individual blocks and performs orthogonal transforms on the prediction errors. The transform section 103 performs orthogonal transforms on the individual blocks having a predetermined size to calculate orthogonal transform coefficients. The blocks to be subjected to orthogonal transforms are hereinafter referred to as transform blocks. Similarly, the determined size of each transform block is referred to as a transform block size. In this embodiment, although the prediction error of each block of 8*8 pixels is partitioned into two in the vertical and lateral directions, and an orthogonal transform is performed on each of the transform block of 4*4 pixels, the size of the transform blocks is not limited thereto. Orthogonal transforms may be performed on transform blocks having the same size as the blocks, or alternatively, orthogonal transforms may be performed on transform blocks partitioned into smaller blocks than those partitioned into two in the vertical and lateral directions. The transform matrices used are not limited to the transform matrices denoted by 200 in FIG. 2A and 201 in FIG. 2B; another transform matrix may be used. For example, a transform matrix whose elements are adjusted may be used to increase the processing speed and calculation accuracy. For orthogonal transforms, the Karhunen-Loeve transform, the Hadamard transform, and so on may be used in addition to the discrete cosine transform and the discrete sine transform.

Reference numeral 107 denotes a quantization-matrix selecting section that receives the orthogonal transform methods determined by the transform section 103 and selects a quantization matrix to be applied from the quantization matrices stored in the quantization-matrix storage section 108.

Reference numeral 104 denotes a quantization section that quantizes the orthogonal transform coefficients by using the quantization matrix selected by the quantization-matrix selecting section 107. Thus, the quantization coefficients can be obtained by the quantization.

Reference numeral 105 denotes a coefficient coding section that codes the thus-obtained quantization coefficient to create quantization-coefficient code data. A method for coding is not particularly limited; for example, Huffman coding and arithmetic coding can be used.

Reference numeral 109 denotes a quantization-matrix coding section that codes the quantization matrices stored in the quantization-matrix storage section 108 to create quantization-matrix code data. A method for coding the quantization matrices is not particularly limited; for example, Huffman code and arithmetic code can be used for the value of each of the elements of the quantization matrices, a difference from the value of the immediately preceding element, or a difference from another quantization matrix.

Reference numeral 106 denotes an integral coding section that creates header information and codes for prediction and transform and integrates the quantization-coefficient code data created by the coefficient coding section 105 and the quantization-matrix code data created by the quantization-matrix coding section 109. Examples of the codes for prediction and transform are codes of selected prediction methods and so on.

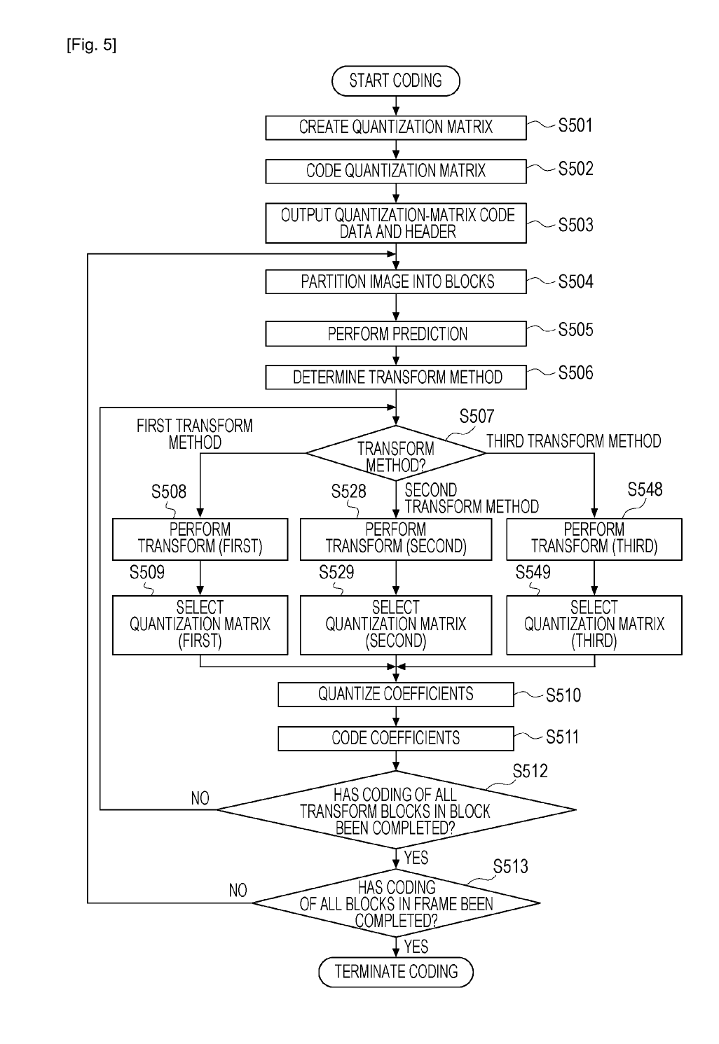

FIG. 5 shows a flowchart of the image coding process of the image coding apparatus according to the first embodiment. Although this embodiment is configured to input movie data frame by frame, it is possible to input still-image data of one frame. In this embodiment, although only an intra-prediction coding process is described for ease of explanation, the present invention is not limited thereto and can also be applied to an inter-prediction coding process.

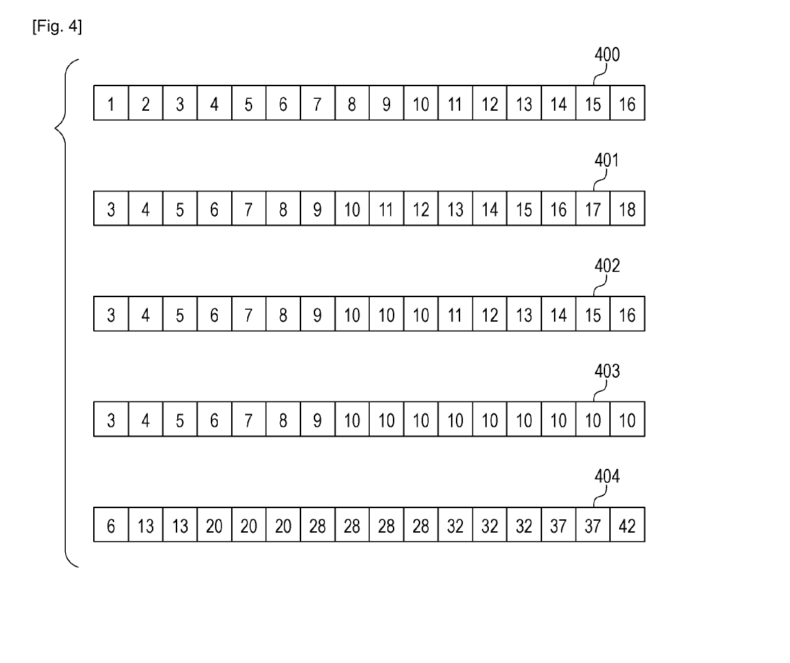

In step S501, the quantization-matrix storage section 108 stores quantization matrices used in quantizing the frame, that is, quantization matrices corresponding to the individual orthogonal transform methods. In this embodiment, the quantization-matrix storage section 108 stores a first quantization matrix corresponding to a first transform method, a second quantization matrix corresponding to a second transform method, and a third quantization matrix corresponding to a third transform method. In this embodiment, although a quantization matrix 400 in FIG. 4 is assumed to be the first quantization matrix, a quantization matrix 401 is assumed to be the second quantization matrix, and a quantization matrix 402 is assumed to be the third quantization matrix, it is needless to say that the elements of the individual quantization matrices are not limited thereto. In this embodiment, the transform block comes in one size of 4*4 pixels, and the orthogonal transform method comes in three kinds, that is, the first transform method, the second transform method, and the third transform method. Therefore, three kinds of quantization matrix are stored. However, the quantization-matrix storage section 108 actually stores quantization matrices as many as combinations of a transform block size and an orthogonal transform method.

In step S502, the quantization-matrix coding section 109 reads quantization matrices from the quantization-matrix storage section 108 in sequence by orthogonal transform methods and codes the quantization matrices to create quantization-matrix code data. Although this embodiment uses a method of directly coding the elements, a method of coding a difference from the immediately preceding element, a differential pulse code modulation (DPCM), and a method of coding a difference from another quantization matrix, the present invention is not limited thereto. In addition to the above, if the same value continues, inserting a code for discontinuing the coding, thereby reducing the amount of codes of the quantization matrix.

Specific examples of the methods for coding quantization matrices will be described with reference to FIG. 4. For ease of explanation, the quantization matrices have a 16-pixel configuration corresponding to a 4*4 pixel transform block, and the individual squares in the thick frames represent the elements. Here, the coding method will be described using five kinds of quantization matrix, denoted by reference numerals 400 to 404 by way of example.

The quantization matrix 400 is an example in which the elements starts from 1 and increases by one at a time. For example, when coding this quantization matrix 400, values from 1 to 16 are coded one by one. As an alternative, after the first element, 1, is coded, the difference from the immediately preceding element, that is, the difference value, 1, in this example, may be coded 15 times. As another alternative, after the difference, 1, between the first element and the second element, is coded, the predicted difference, 0, may be coded, as in the DPCM.

The quantization matrix 401 is an example in which the elements starts from 3 and increases by one at a time. For example, when coding the quantization matrix 401, values from 3 to 18 are coded one by one. As an alternative, after the first element, 3, is coded, the difference from the immediately preceding element, that is, the difference value, 1, in this example, may be coded 15 times. As another alternative, the difference from the values of the elements of the quantization matrix 400, that is, the difference value, 1, in this example, may be coded 16 times.

The quantization matrix 402 is an example in which the elements starts from 3 and increases to 10 one at a time, and after 10 continues three times, the value increases to 16 one at a time. For example, when coding the quantization matrix 402, the values of the elements are coded one by one, as for 400 and 401. The difference from the immediately preceding element, or the difference from corresponding one of the elements of another quantization matrix may be coded. When coding the difference between the values of the elements of the quantization matrix 402 and the values of the elements in the quantization matrix 400, the difference value, 2, is coded from the first 3 to the first 10, and the difference value, 1, is coded for the second 10. Since the difference value of the third 10 onward is 0, the difference value, 0, is coded seven times. A method for reducing the amount of the codes of difference values by coding a code that represents discontinuing the coding may be used.

A quantization matrix 403 is an example in which the elements starts from 3 and increases to 10 by 1, and thereafter remains at 10 to the end. For example, when coding the quantization matrix 403, the values of the elements are coded one by one, like the quantization matrices 400 and 401. As an alternative, the difference from the immediately preceding element or the differences from the elements of another quantization matrix may be coded. When coding the differences between the individual elements of the quantization matrix 403 and the immediately preceding elements, the difference value, 1, is coded from the first 3 to the first 10. Since the difference values between the following elements 10 remains 0 to the end, the difference value, 0, is coded seven times. A method for reducing the amount of the codes of the difference values by coding a code that represents discontinuing the coding may be used.

The quantization matrix 404 is an example in which the elements start from 6 and increases gradually. For example, when coding the quantization matrix 404, the values of the individual elements are coded one by one, as in the quantization matrices 400 and 401. The difference from the immediately preceding element, or the difference from corresponding one of the elements of another quantization matrix may be coded. When coding the differences between the elements of the quantization matrix 404 and the immediately preceding elements, the first element 6 is first coded. Thereafter, the difference value from the immediately preceding element is coded. That is, the difference value 7, 0, 7, 0, 0, 8, 0, 0, 0, 4, 0, 0, 5, 0, and 5 are coded in this order. The methods for coding quantization matrices, described above, are described merely for the purpose of explanation, and the present invention is not limited thereto.

In step S503, the integral coding section 106 codes the headers of the bit stream and outputs it. Here, the quantization-matrix code data coded in step S502 is output together with the headers.

The integral coding section 106 creates codes of the headers of the sequence, frame, picture, and slice of the image. The quantization-matrix code data created by the quantization-matrix coding section 109 is inserted into any of the headers. The integral coding section 106 integrates the codes of the headers and the quantization-coefficient code data created by the coefficient coding section 105 to create a bit stream and outputs the bit stream. In step S504, the image partitioning section 101 partitions the frame-by-frame input image into blocks (8*8 pixels). The partitioned image data is input to the prediction section 102.

In step S505, the prediction section 102 performs a prediction on each of the blocks to create auxiliary information and a prediction error for determining a method for prediction and a method for orthogonal transform. In this embodiment, although the auxiliary information is information on a method for intra-prediction, the present invention is not limited thereto, and information on a method for motion-compensation prediction and information on a transform method are possible.

In step S506, the transform section 103 determines a method for orthogonal transform by using the auxiliary information created by the prediction section 102 and determines a transform block size for the prediction error and performs an orthogonal transform, thereby creating an orthogonal transform coefficient.

In the method of determining an orthogonal transform method of this embodiment, for prediction from the left block of the blocks, the intra-prediction method performs the transform matrix 200 in FIG. 2 for the vertical transform and uses the transform matrix 201 in FIG. 2 for the horizontal transform. This is hereinafter referred to as a first transform method. For prediction from the upper block of the blocks, the intra-prediction method uses the transform matrix 201 for the vertical transform and uses the transform matrix 200 for the horizontal transform. This is hereafter referred to as a second transform method. For the other cases, the intra-prediction method uses the transform matrix 200 for both of the vertical transform and the horizontal transform. This is hereinafter referred to as a third transform method. However, the present invention is not limited to the combinations of a prediction method and an orthogonal transform method. The determined orthogonal transform method is input to the quantization-matrix selecting section 107, and the determined orthogonal transform coefficient is input to the quantization section 104.

In step S507, the quantization-matrix selecting section 107 selects a quantization matrix for use in quantization of the block by using the orthogonal transform method determined by the transform section 103. Specifically, a quantization matrix for use in quantization of the transform block from the quantization matrices stored in the quantization-matrix storage section 108. For example, in this embodiment, if the orthogonal transform method is the second transform method, the second quantization matrix is input from the quantization-matrix storage section 108 and is output to the quantization section 104. If the orthogonal transform method is the first transform method, the process proceeds to S508, if the method is the second transform method, the process proceeds to S528, if the method is the third transform method, the process proceeds to S548.

In step S508, the transform section 103 performs an orthogonal transform on the prediction error created in step S505 b using the first transform method to create an orthogonal transform coefficient.

In step S509, the quantization-matrix selecting section 107 selects the first quantization matrix 400 in FIG. 4 from the quantization matrix created in step S501 by using the orthogonal transform method determined in step S506.

In step S528, the transform section 103 performs an orthogonal transform on the prediction error created in step S505 by using the second transform method, to create an orthogonal transform coefficient.

In step S529, as in step S509, the quantization-matrix selecting section 107 selects the second quantization matrix 401 from the quantization matrices created in step S501 by using the orthogonal transform method determined in step S506.

In step S548, the transform section 103 performs an orthogonal transform on the prediction error created in step S505 by using the third transform method to create an orthogonal transform coefficient.

In step S549, as in step S509, the quantization-matrix selecting section 107 selects the third quantization matrix 402 from the quantization matrices created in step S501 by using the orthogonal transform method determined in step S506.

In step S510, the quantization section 104 quantizes the orthogonal transform coefficients created in steps S508, S528, and S548 by using the quantization matrices selected in steps S509, S529, and S549 to create quantization coefficients. The created quantization coefficients are input to the coefficient coding section 105. In step S511, the coefficient coding section 105 codes the quantization coefficients created in step S510 to create quantization-coefficient code data and outputs the code data to the integral coding section 106. In step S512, the image coding apparatus determines whether the coding of all the transform blocks in the block has been completed, and if the coding has been completed, the process proceeds to step S513, and if the coding has not been completed, the process returns to step S507 for the next transform block.

In step S513, the image coding apparatus determines whether the coding of all the blocks has been completed, and if the coding has been completed, all the operations are stopped to complete the process, and if the coding has not been completed, the process returns to step S504 for the next block.

The foregoing configuration and operation, particularly, the processes in steps S501, S509, S529, and S549, allow a bit stream quantized by using an optimum quantization matrix depending the orthogonal transform method to be created.

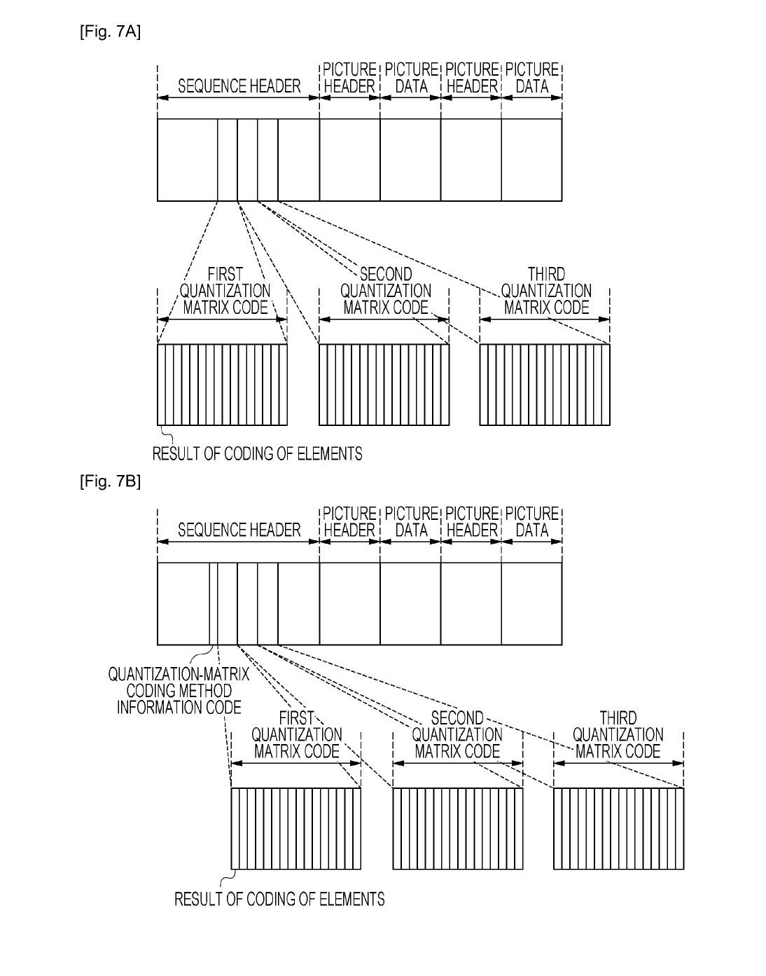

FIG. 7A shows an example of the bit stream output in the first embodiment. In this embodiment, although the sequence header portion in the bit stream includes coded quantization matrices, the position of coding is not limited thereto. The picture header portion or another header portion may be coded. When changing the quantization matrices in one sequence, the quantization matrices can be updated by newly coding the quantization matrices. In this case, either all the quantization matrices may be rewritten or part of the quantization matrices may be changed by indicating an orthogonal transform method for the target quantization matrix. It is needless to say that part of the quantization matrices can be changed by indicating an orthogonal transform method for the target quantization matrix and the position of the element to be changed.

Although this embodiment has been described using a frame for which only intra-prediction is used by way of example, it is obvious that the present invention can be applied to a frame for which inter-prediction can be used.

Furthermore, the transform block in this embodiment comes in one size. In the case where the transform block comes in two or more sizes, it is necessary to create, store, and select a quantization matrix depending on the size of the transform block. For example, in this embodiment, although an 8*8 pixel block is partitioned into a transform block size of 4*4 pixels, a transform of 8*8 pixels may be added. In the case where a transform block size of 8*8 pixels and a corresponding transform method for the 8*8 pixels are used, a fourth quantization matrix corresponding to the transform method for the 8*8 pixels is created and coded. In this case, the transform block size is determined by the transform section 103, and the result is output to the quantization-matrix selecting section 107 and the integral coding section 106. The quantization-matrix storage section 108 creates and stores quantization matrices corresponding to the individual transform blocks. Here, a quantization matrix corresponding to the 8*8 pixels is newly added. The quantization-matrix selecting section 107 selects a quantization matrix for use in quantizing the block by using the orthogonal transform method and the transform block size determined by the transform section 103. The integral coding section 106 codes the transform block size and outputs it. A quantization matrix corresponding to a different transform block size may be coded using a quantization matrix corresponding to the transform block size. For example, it is also possible to code a quantization matrix of 8*8 pixels in the units of pixels and to code a quantization matrix of 4*4 pixels by using the mean value of 2*2 pixels in the quantization matrix of 8*8 pixels as a prediction value, and to code the difference therebetween. Although the description is made for the case of one transform of the 8*8 pixel block, the present invention is not limited thereto; for two or more kinds of transform, as for the 4*4 pixels, transform methods and quantization matrices may be prepared therefor.

Furthermore, in this embodiment, although a block of 8*8 pixels and a transform block of 4*4 pixels are used for ease of explanation, the present invention is not limited thereto. For example, changes to block sizes of 16*16 pixels and 32*32 pixels are possible, and the shape of the block is not limited to a square, and a rectangle of 16*8 pixels or the like is also possible.

Although this embodiment uses three kinds of orthogonal transform method, that is, the first transform method, the second transform method, and the third transform method on the basis of the transform matrices shown in FIG. 2, the present invention is not limited thereto; it is also possible to use a method based on a transform matrix that is more suitable to increasing the speed and accuracy.

Although the transform block size is set to half of the block size in the vertical and lateral directions, it is needless to say that they may have the same size or may be smaller than the half in the vertical and lateral directions.

Although the coding of quantization matrices has been described using the method of coding the individual elements, the present invention is not limited thereto.

In this embodiment, although the method of setting orthogonal transform methods for individual blocks has been described, the present invention is not limited thereto; for example, the methods may be set for individual transform blocks.

Although this embodiment has been described using the intra-prediction method as auxiliary information for selecting an orthogonal transform method, the present invention is not limited thereto; it is also possible to code the auxiliary information for selecting an orthogonal transform method and to include the information in the bit stream. For example, it is also possible to use a method of selecting a transform in which power is most concentrated by trying all orthogonal transforms or a method of extracting an edge in the block and selecting a transform along the direction thereof without depending on the prediction method. It is also possible to use a method of coding the selection result as the auxiliary information for selecting an orthogonal transform method.

### Second Embodiment

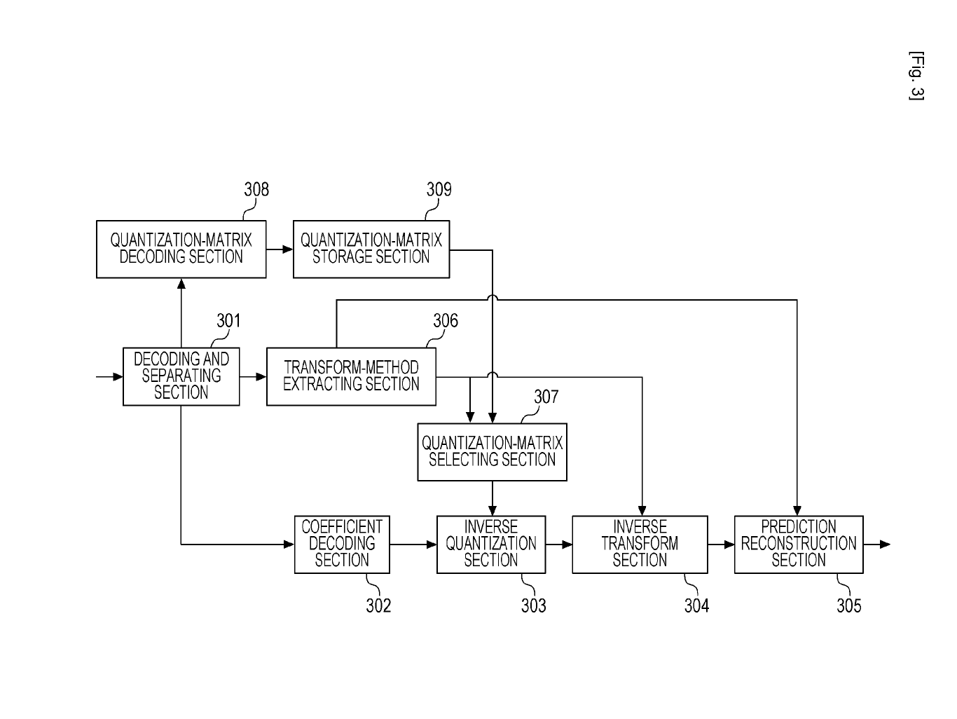

FIG. 3 is a block diagram showing the configuration of an image decoding apparatus according to a second embodiment of the present invention. In this embodiment, decoding of the bit stream created in the first embodiment shown in FIG. 1 will be described.

In FIG. 3, reference numeral 301 denotes a decoding and separating section that decodes the header information of an input bit stream, separates necessary codes from the bit stream, and outputs the codes to the subsequent stages. The decoding and separating section 301 performs an operation opposite to the integral coding section 106 in FIG. 1.

Reference numeral 308 denotes a quantization-matrix decoding section that extracts quantization-matrix code data from the header information of the bit stream and decodes it.

Reference numeral 309 denotes a quantization-matrix storage section that temporarily stores the quantization matrices decoded by the quantization-matrix decoding section 308.

Reference numeral 306 denotes a transform-method extracting section that decodes prediction information of individual blocks from the codes separated by the decoding and separating section 301 and determines an orthogonal transform method on the basis of the prediction information.

Reference numeral 307 denotes a quantization-matrix selecting section that selects one of the quantization matrices stored by the quantization-matrix storage section 309 on the basis of the orthogonal transform method determined by the transform-method extracting section 306.

Reference numeral 302 denotes a coefficient decoding section that decodes quantization coefficient codes from the codes separated by the decoding and separating section 301 to reproduce quantization coefficients.

Reference numeral 303 denotes an inverse quantization section that inversely quantizes the quantization coefficients by using the quantization matrix selected by the quantization-matrix selecting section 307 to reproduce orthogonal transform coefficients.

Reference numeral 304 denotes an inverse transform section that performs an inverse orthogonal transform opposite to the transform section 103 in FIG. 1 to reproduce a prediction error.

Reference numeral 305 denotes a prediction reconstructing section that reproduces image data of the block from prediction information, the prediction error, and the decoded image data.

The image decoding operation of the image decoding apparatus will be described hereinbelow. Although this embodiment is configured to input the video bit stream created in the first embodiment in the units of frames, a still-image bit stream of one frame may be input. Although only intra-prediction coding is described in this embodiment for ease of explanation, the present invention is not limited thereto and can be applied also to inter-prediction decoding.

Referring to FIG. 3, the input one-frame stream data is input to the decoding and separating section 301, where header information necessary for reproducing the image is decoded, and codes for use in the subsequent stage are separated and output. Quantization-matrix code data included in the header information is input to the quantization-matrix decoding section 308, where quantization matrices corresponding to orthogonal transform methods are reproduced as quantization matrices for use in the subsequent inverse quantization process. In this embodiment, three kinds of quantization matrices, that is, the first quantization matrix corresponding to the first transform method, the second quantization matrix corresponding to the second transform method, and the third quantization matrix corresponding to the third transform method, are reproduced. In this embodiment, since the transform block comes in one size of 4*4 pixels, and the orthogonal transform method comes in three kinds, the first, second, and third, three kinds of quantization matrices are reproduced. Actually, quantization matrices as many as the number of combinations of transform block size and orthogonal transform methods are reproduced. The reproduced quantization matrices are input to the quantization-matrix storage section 309 and are temporarily stored therein.

Of the codes separated by the decoding and separating section 301, codes for prediction are input to the transform-method extracting section 306, where they are decoded, and thus information indicating a prediction method and an orthogonal transform method is created. The orthogonal transform method is output to the quantization-matrix selecting section 307 and the inverse transform section 304. The decoded prediction method is output to the prediction reconstructing section 305. In this embodiment, information indicating any of the first transform method, the second transform method, and the third transform method is created on the basis of information about intra-prediction. For example, if prediction is performed from the left of the block, the second transform method is selected.

The quantization-matrix selecting section 307 selects one of the quantization matrices stored in the quantization-matrix storage section 309 in accordance with the input information on the orthogonal transform method and outputs the quantization matrix to the inverse quantization section 303. For example, in this embodiment, if the orthogonal transform method is the second transform method, the second quantization matrix is selected from the quantization-matrix storage section 309 and is output to the inverse quantization section 303.

Furthermore, of the codes separated by the decoding and separating section 301, quantization-coefficient code data is input to the coefficient decoding section 302. The quantization-coefficient code data is decoded to reproduce a quantization coefficient, and the quantization coefficient is output to the inverse quantization section 303.

The inverse quantization section 303 receives the quantization matrix selected by the quantization-matrix selecting section 307 and the quantization coefficient reproduced by the coefficient decoding section 302. The inverse quantization section 303 performs an inverse transform by using the quantization matrix to reproduce an orthogonal transform coefficient, and outputs the orthogonal transform coefficient to the inverse transform section 304.

The inverse transform section 304 receives the reproduced orthogonal transform coefficient, performs an inverse orthogonal transform opposite to the transform section 103 in FIG. 1 to reproduce a prediction error, and outputs the prediction error to the prediction reconstructing section 305.

The prediction reconstructing section 305 performs a prediction on the input prediction error in accordance with the intra-prediction method decoded by the transform-method extracting section 306 from the decoded surrounding pixel data to reproduce image data in units of blocks and outputs the image data.

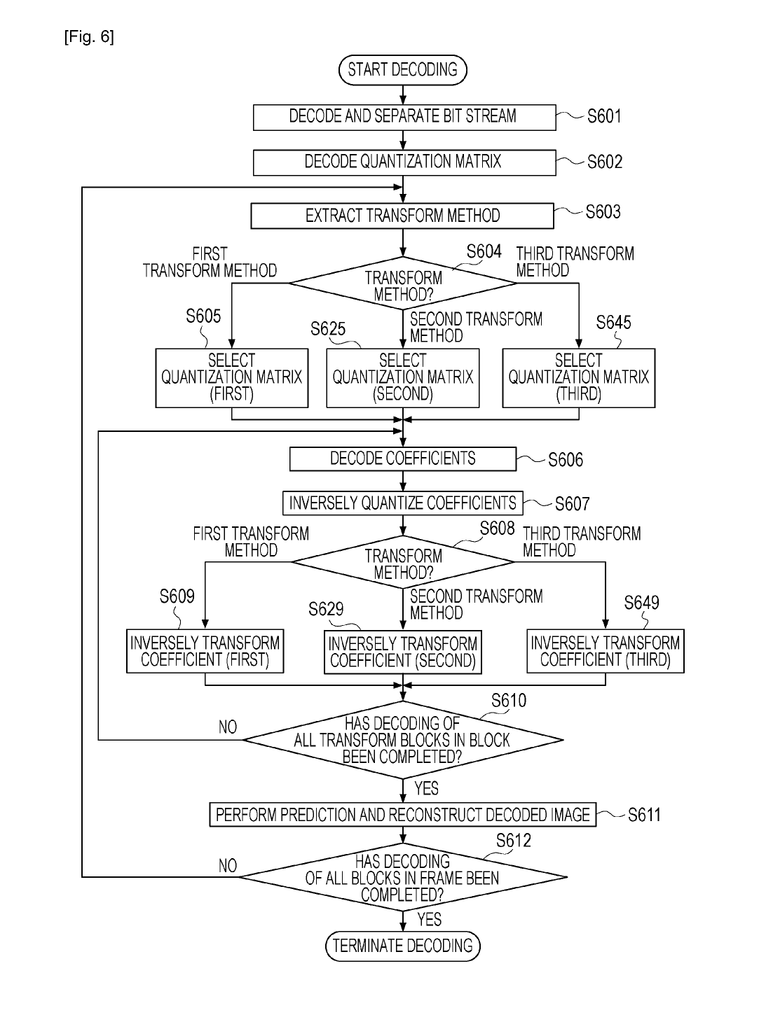

FIG. 6 is a flowchart of the image decoding process of the image decoding apparatus according to the second embodiment.

First, in step S601, the decoding and separating section 301 decodes header information.

In step S602, the quantization-matrix decoding section 308 decodes quantization-matrix code data included in the header information, so that quantization matrices for use in the subsequent inverse quantization process are reproduced. The decoded quantization matrix is stored in the quantization-matrix storage section 309. In this embodiment, three kinds of quantization matrices corresponding to the individual orthogonal transform methods, that is, the first transform method, the second transform method, and the third transform method for 4*4 pixels, are decoded and reproduced in sequence. However, the order of decoding is not limited thereto.

In step S603, the transform-method extracting section 306 decodes information about intra-prediction on a block-by-block basis and creates orthogonal transform method information from the information.

In step S604, a determination based on the orthogonal transform method information created in step S603 is performed. If the orthogonal transform method is the first transform method, the process proceeds to S605, if the method is the second transform method, the process proceeds to S625, and the method is the third transform method, the process proceeds to S645.

In step S605, the quantization-matrix selecting section 307 selects a quantization matrix to be applied to the transform block on the basis of the orthogonal transform method information extracted in step S603. Specifically, the quantization-matrix selecting section 307 selects the first quantization matrix because the extracted orthogonal transform method information is the first transform method.

In step S625, the quantization-matrix selecting section 307 selects a quantization matrix to be applied to the transform block on the basis of the orthogonal transform method information. Specifically, the quantization-matrix selecting section 307 selects the second quantization matrix because the extracted orthogonal transform method information is the second transform method.

In step S645, the quantization-matrix selecting section 307 selects a quantization matrix to be applied to the transform block on the basis of the orthogonal transform method information. Specifically, the quantization-matrix selecting section 307 selects the third quantization matrix because the extracted orthogonal transform method information is the third transform method. In step S606, the coefficient decoding section 302 decodes the quantization-coefficient code data in units of transform blocks to reproduce quantization coefficients.

In step S607, the inverse quantization section 303 inversely quantizes the quantization coefficients reproduced in step S606 by using the quantization matrices selected in step S605, S625, and S645 to reproduce orthogonal transform coefficients.

In step S608, a determination based on the orthogonal transform method information created in step S603 is performed again. If the orthogonal transform method is the first transform method, the process proceeds to step S609, if the method is the second transform method, the process proceeds to S629, and if the method is the third transform method, the process proceeds to step S649. In step S609, the inverse transform section 304 performs an inverse orthogonal transform based on the first transform method on the orthogonal transform coefficients reproduced in step S607 to reproduce a prediction error. In step S629, the inverse transform section 304 performs an inverse orthogonal transform based on the second transform method on the orthogonal transform coefficients reproduced in step S607 to reproduce a prediction error. In step S649, the inverse transform section 304 performs an inverse orthogonal transform based on the third transform method on the orthogonal transform coefficients reproduced in step S607 to reproduce a prediction error.

In step S610, the image decoding apparatus determines whether decoding of all the transform blocks in the block has been completed, in which if the decoding has been completed, the process proceeds to step S611, and if the decoding has not been completed, the process returns to step S606 for the next transform block.

In step S611, the prediction reconstructing section 305 performs a prediction from the decoded surrounding pixel data in accordance with the prediction method decoded in step S603, and it is added to the prediction errors reproduced in steps S609, S629, and S649 to reproduce a decoded image of the block.

In step S612, the image decoding apparatus determines whether decoding of all the blocks has been completed, in which if the decoding has been completed, all the operations are stopped to terminate the process, and if not, the process returns to step S603 for the next block.

The above configuration and operation allow the bit stream, which is created in the first embodiment through a quantization process using an optimum quantization matrix corresponding to the orthogonal transform method, to be decoded, thus allowing a reproduced image to be acquired.

The size of the block, the size of the transform block, and the shape of the block are not limited, as in the first embodiment.

Although a method of setting an orthogonal transform method for each block has been described in this embodiment, the present invention is not limited thereto; it is needless to say that the method may be set, for example, for each transform block. In this case, step S611 is performed before step S610.

Furthermore, in this embodiment, the transform block comes in one size. However, in the case where the transform block comes in two or more sizes, it is necessary to create, store, and select a quantization matrix depending on the size of the transform block. For example, in this embodiment, although an 8*8 pixel block is partitioned into a transform block size of 4*4 pixels, transform of 8*8 pixels may be added. In the case where the transform block size of 8*8 pixels and a corresponding transform method for 8*8 pixels are used, a fourth quantization matrix corresponding to the transform method for 8*8 pixels is decode and stored, and is selected in accordance with information of the transform block size. In this case, the decoding and separating section 301 decodes the code of the transform block size to reproduce a transform block size. The quantization-matrix decoding section 308 decodes quantization matrices corresponding to the individual transform blocks, and the quantization-matrix storage section 309 stores the quantization matrices corresponding to the individual transform blocks. The quantization-matrix selecting section 307 selects quantization matrices for use in the inverse quantization of the block in accordance with the transform block size reproduced by the decoding and separating section 301 and the transform method reproduced by the transform-method extracting section 306.

In the case where a plurality of items of quantization-matrix code data are included in a single sequence, the quantization matrices can also be updated. The decoding and separating section 301 detects quantization-matrix code data, and the quantization-matrix decoding section 308 decodes it. The decoded quantization matrix data is replaced with a corresponding quantization matrix in the quantization-matrix storage section 309. In this case, all the quantization matrices may be rewritten or part thereof may be change by determining the orthogonal transform method and the transform block size of the target quantization matrix. Furthermore, of course, it is also possible to change part of the elements in the matrix by determining the orthogonal transform method and the transform block size of the target quantization matrix and the position of the element.

In this embodiment, although an orthogonal transform method is determined by creating orthogonal transform method information from a coded intra-prediction method, the present invention is not limited thereto. If orthogonal transform method information code data is included, the orthogonal transform method may be determined by decoding the code data.

### Third Embodiment

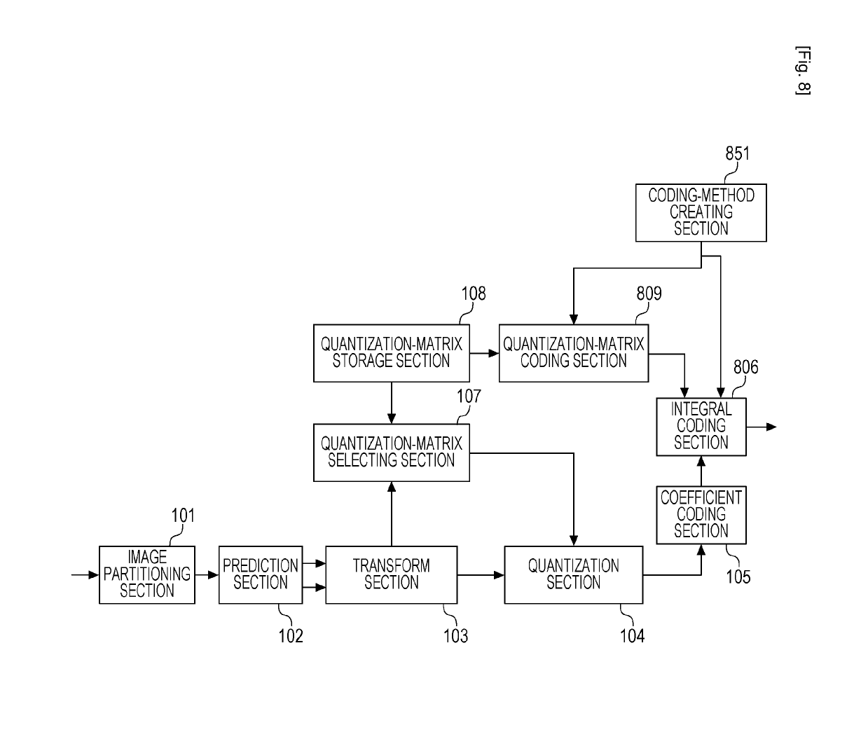

FIG. 8 is a block diagram of an image coding apparatus of a third embodiment of the present invention. In FIG. 8, components that function as in the first embodiment of FIG. 1 are given the same reference numerals, and descriptions thereof will be omitted.

Reference numeral 851 denotes a coding-method creating section that creates quantization-matrix coding method information indicating how to code individual quantization matrices.

Reference numeral 809 denotes a quantization-matrix coding section that codes the quantization matrices stored in the quantization-matrix storage section 108 to create quantization-matrix code data on the basis of the quantization-matrix coding method information created by the coding-method creating section 851.

Reference numeral 806 denotes an integral coding section that creates header information and codes for prediction and transform similarly to the integral coding section 106 in FIG. 1 and differs from the integral coding section 106 in that it receives quantization-matrix coding method information from the coding-method creating section 851 and codes it.

An image coding operation of the image coding apparatus will be described hereinbelow.

The coding-method creating section 851 first creates quantization-matrix coding method information indicating how to code the individual quantization matrices. In this embodiment, if the quantization-matrix coding method information is 0, a method of directly coding the elements of the quantization matrices is used. If the quantization-matrix coding method information is 1, a method of coding a difference from the immediately preceding element is used, and if the quantization-matrix coding method information is 2, a difference from an element at the same position of the immediately preceding coded quantization matrix is used. The coding method for the elements of the quantization matrices is not limited thereto; after the difference between the first element and the second element is coded, as in the DPCM, a predicted difference may be coded. Furthermore, of course, a method of coding with reference to the preceding decoded quantization matrix or a coded quantization matrix indicated by another code may be used. A combination of a quantization-matrix coding method information and a quantization-matrix coding method is not limited thereto. A method for creating quantization-matrix coding method information is not particularly limited; the method may be input by the user, a fixed value that is designated in advance may be used, or, of course, the method may be calculated from the characteristics of the quantization matrices stored in the quantization-matrix storage section 108. The created quantization-matrix coding method information is input to the quantization-matrix coding section 809 and the integral coding section 806.

The quantization-matrix coding section 809 codes the individual quantization matrices stored in the quantization-matrix storage section 108 on the basis of the input quantization-matrix coding method information to create quantization-matrix code data and outputs the data to the integral coding section 806.

The integral coding section 806 codes the quantization-matrix coding method information created by the coding-method creating section 851 to create quantization-matrix coding method information code and outputs the code together with header information and the like. A method for coding is not particularly limited; for example, Huffman coding and arithmetic coding can be used. FIG. 7B shows an example of a bit stream including the quantization-matrix coding method information code. Although the quantization-matrix coding method information code may be placed in any of the sequence header and the picture header, it is placed in front of the quantization-matrix code data.

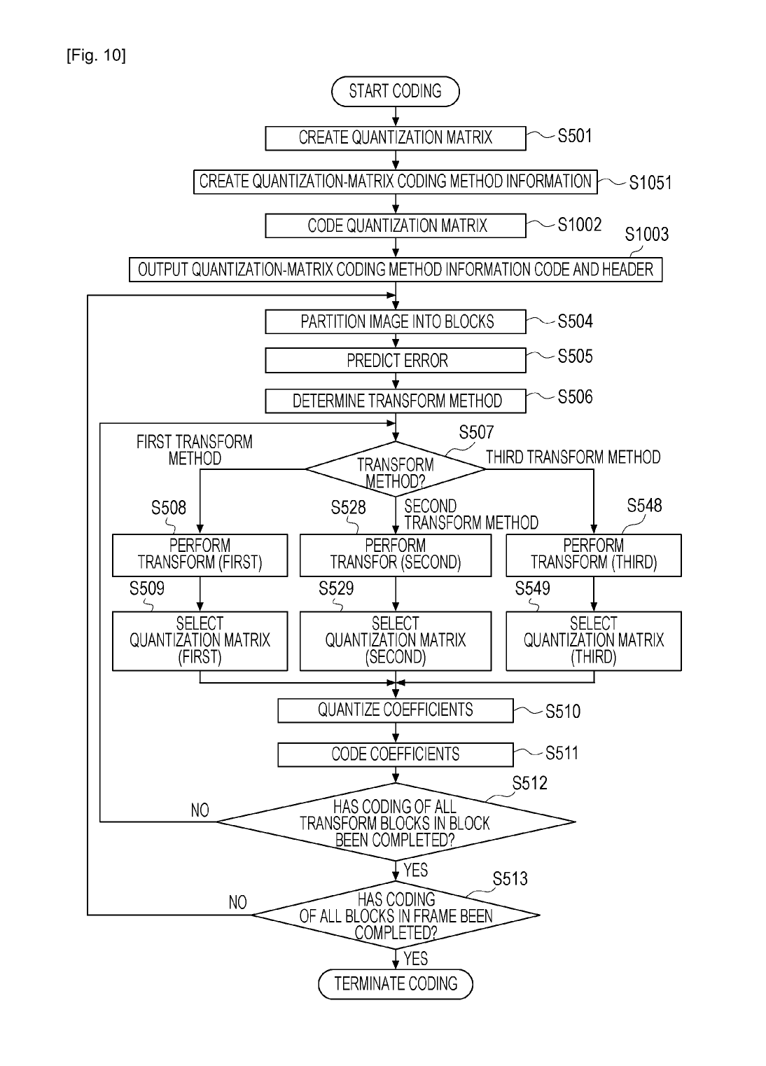

FIG. 10 is a flowchart of the image coding process of the image coding apparatus according to the third embodiment. In FIG. 10, the steps of performing the same functions as in the first embodiment of FIG. 5 are given the same reference numerals, and descriptions thereof will be omitted.

In step S1051, the coding-method creating section 851 determines a quantization-matrix coding method for use in the subsequent step S1002.

In step S1002, the quantization-matrix coding section 809 codes the quantization matrices created in step S501 on the basis of the quantization-matrix coding method determined in step S1051.

In step S1003, the integral coding section 806 codes quantization-matrix coding method information to create quantization-matrix coding method information code and outputs the code together with other codes in combination with the header portion.

The foregoing configuration and operation allow the individual quantization matrices to be coded by an optimum coding method, thus allowing a bit stream quantized by using optimum quantization matrices depending on the orthogonal transform methods to be created. This can reduce the amount of codes created by coding quantization matrices.

Although this embodiment has been described using a case where one coding method is selected for all the target quantization matrices by way of example, the present invention is not limited thereto. It is needless to say that a coding method may be selected in units of quantization matrices or may be selected for each of transform block sizes or transform methods.

### Fourth Embodiment

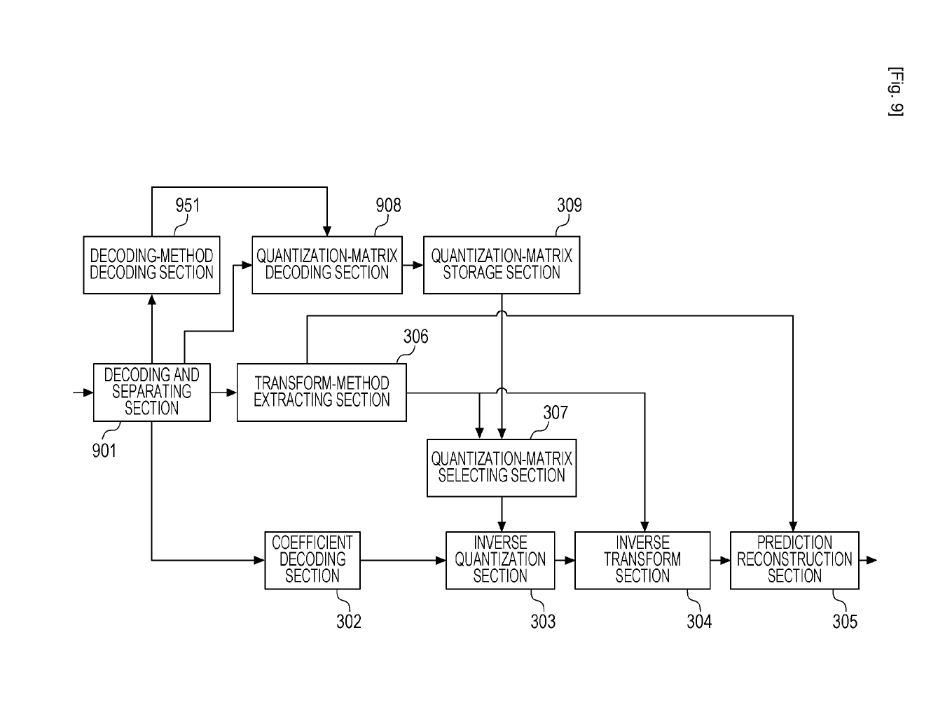

FIG. 9 is a block diagram showing an image decoding apparatus of a fourth embodiment of the present invention. In FIG. 9, components that function as in the second embodiment of FIG. 3 are given the same reference numerals, and descriptions thereof will be omitted.

Reference numeral 901 denotes a decoding and separating section that decodes the header information of an input bit stream, separates necessary codes from the bit stream, and outputs the codes to the subsequent stage. This differs from the decoding and separating section 301 in FIG. 3 in that it separates quantization-matrix coding information code from the header information of the bit stream and outputs it to the subsequent stage.

Reference numeral 951 denotes a decoding-method decoding section that decodes the quantization-matrix coding information code separated by the decoding and separating section 901 to reproduce quantization-matrix coding method information.

Reference numeral 908 denotes a quantization-matrix decoding section that decodes the quantization-matrix code data separated from the header information of the bit stream by the decoding and separating section 901 on the basis of the quantization-matrix coding method information.

The image decoding operation of the image decoding apparatus will be described hereinbelow.

In FIG. 9, one frame of input stream data is input to the decoding and separating section 901, where header information necessary for reproducing an image is decoded, and codes for use in the subsequent stage are separated and output. Quantization-matrix coding information code included in the header information is input to the decoding-method creating section 951, where quantization-matrix coding method information is reproduced. The reproduced quantization-matrix coding method information is input to the quantization-matrix decoding section 908.

Quantization-matrix code data included in the header information is input to the quantization-matrix decoding section 908. The quantization-matrix decoding section 908 selects a quantization-matrix decoding method on the basis of the input quantization-matrix coding method information and decodes the quantization-matrix code data to reproduce quantization matrices for use in the subsequent inverse quantization processes.

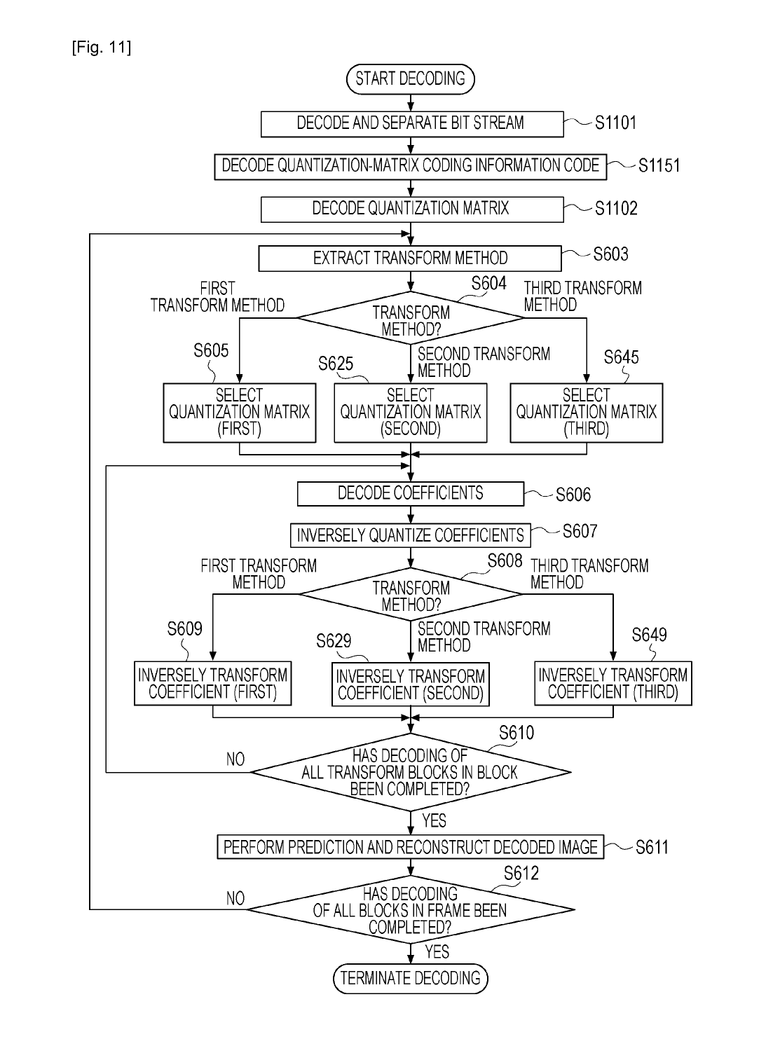

FIG. 11 is a flowchart of the image decoding process of the image decoding apparatus according to the fourth embodiment. The steps of performing the same functions as in the second embodiment of FIG. 6 are given the same reference numerals, and descriptions thereof will be omitted.

In step S1101, the decoding and separating section 901 decodes header information.

In step S1151, the decoding-method decoding section 951 decodes a quantization-matrix coding information code included in the header information to reproduce quantization-matrix coding method information.

In step S1102, the quantization-matrix decoding section 908 selects a quantization-matrix decoding method on the basis of the quantization-matrix coding method information reproduced in step S1151 and decodes quantization-matrix code data included in the header information to reproduce a quantization matrix.

The foregoing configuration and operation allow the individual quantization matrices created in the first embodiment to be coded by an optimum coding method and allow a bit stream quantized by using the optimum quantization matrices depending on the orthogonal transform methods to be decoded, thus allowing a reproduced image to be obtained. This can reduce the amount of codes created by coding quantization matrices.

Although this embodiment has been described using a case where one coding method is selected for all quantization matrices to be decoded by way of example, the present invention is not limited thereto. It is needless to say that a coding method may be selected in units of quantization matrices or may be selected for each of transform block sizes or transform methods.

### Fifth Embodiment

In a fifth embodiment of the present invention, the image coding apparatus has the same configuration as in the third embodiment of FIG. 8. However, this differs in the operations of the quantization-matrix storage section 108, the quantization-matrix coding section 809, and the coding-method creating section 851. Accordingly, the operations of the others are the same as in the third embodiment, and descriptions thereof will be omitted.

Although the quantization-matrix storage section 108 in the third embodiment uses three kinds of transform matrices, this embodiment differs therefrom in that it creates quantization matrices for four kinds of transform matrices by different methods and stores the quantization matrices. In this embodiment, the first transform method and the second transform method are the same as those of the first embodiment. In the first transform method and the second transform method, transform coefficients are often folded along the diagonal because of the characteristics of orthogonal transform.

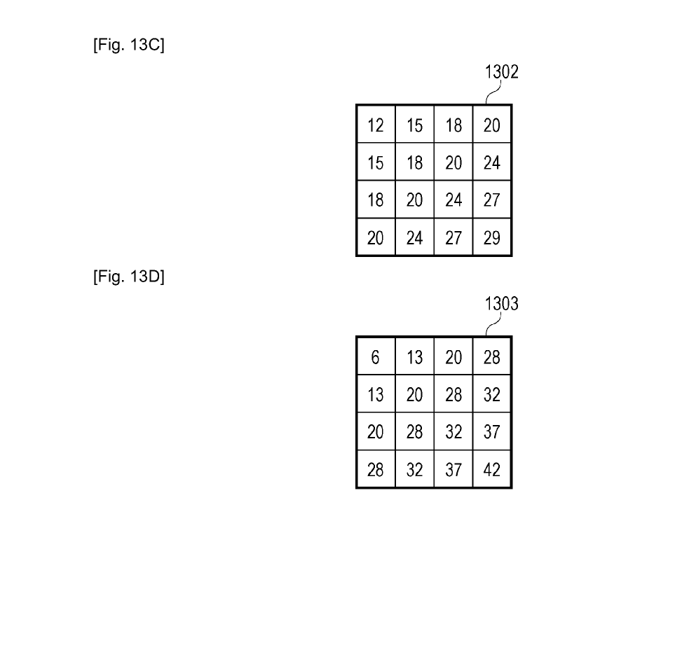

Furthermore, in the case where the intra-prediction method performs a prediction from the mean value of surrounding pixels, the matrix 200 shown in FIG. 2A is used for both the vertical transform and the horizontal transform. Hereinafter, this is referred to as a third transform method. In the other cases, the matrix 201 shown in FIG. 2B is used for both the vertical transform and the horizontal transform. Hereinafter, this is referred to as a fourth transform method. However, a combination of a prediction method and an orthogonal transform method is not limited thereto. As a result, the quantization-matrix storage section 108 stores a first quantization matrix corresponding to the first transform method, a second quantization matrix corresponding to the second transform method, a third quantization matrix corresponding to the third transform method, and a fourth quantization matrix corresponding to the fourth transform method. In this embodiment, a quantization matrix 1300 in FIG. 13A is the first quantization matrix, a quantization matrix 1301 in FIG. 13B is the second quantization matrix, a quantization matrix 1302 in FIG. 13C is the third quantization matrix, and a quantization matrix 1303 in FIG. 13D is the fourth quantization matrix. Of course, elements in the individual quantization matrices are not limited thereto.

The quantization-matrix coding section 809 differs in that it codes the four kinds of quantization matrix created by the quantization-matrix storage section 108. The coding-method creating section 851 differs from the third embodiment in a method for creating quantization-matrix coding method information. Although the third embodiment is provided with a single item of quantization-matrix coding method information at the head of quantization-matrix code data, this embodiment is provided with quantization-matrix coding method information in individual items of quantization-matrix code data.

In this embodiment, the transform block comes in one size of 4*4 pixels, and the orthogonal transform method comes in four kinds, that is, the first transform method, the second transform method, the third transform method, and the fourth transform method. Therefore, four kinds of quantization matrices are stored. However, quantization matrices as many as combinations of transform block size and orthogonal transform methods are stored.

The coding-method creating section 851 first creates quantization-matrix coding method information indicating how to code individual quantization matrices. In this embodiment, if the quantization-matrix coding method information is 0, an immediately preceding quantization matrix is used as it is, and information of the elements of the quantization matrix is not coded. If the quantization-matrix coding method information is 1, difference values between the elements of the target quantization matrix and the immediately preceding element are coded. If the quantization-matrix coding method information is 2, a transposed quantization matrix in which the rows and columns of the immediately preceding quantization matrix are transposed is used, and information of the elements is not coded. However, a combination of quantization-matrix coding method information and a quantization-matrix coding method is not limited thereto.

A method for creating quantization-matrix coding method information is not particularly limited; the method may be input by the user, a fixed value that is designated in advance may be used, or, of course, the method may be calculated from the characteristics of the quantization matrices stored in the quantization-matrix storage section 108. In particular, this embodiment is configured such that a quantization matrix corresponding to the first transform method is the quantization matrix 1300 shown in FIG. 13A, and a quantization matrix corresponding to the second transform method is the quantization matrix 1301 shown in FIG. 13B, which have a transposed relationship in which the rows and columns of the quantization matrices are transposed. Thus, when the quantization matrix corresponding to the second transform method is to be coded, the quantization-matrix coding method information can be set to 2, which allows the amount of codes generated by coding the quantization matrix to be reduced.

Conversely, creating and storing a quantization matrix having a transposed relationship by the quantization-matrix storage section 108 on the assumption that this transposed quantization matrix is used can provide the similar advantage of reducing the amount of codes.

The created quantization-matrix coding method information can be input to the quantization-matrix coding section 809 and the integral coding section 806.

The quantization-matrix coding section 809 codes the quantization matrices stored in the quantization-matrix storage section 108 to create quantization-matrix code data on the basis of the input quantization-matrix coding method information and outputs the coding method information to the integral coding section 806. This differs from the quantization-matrix coding section 809 of the third embodiment in that the coding method is changed in units of quantization matrices in accordance with the quantization-matrix coding method information. This also differs in that coding of the elements is not sometimes performed by using an immediately preceding matrix or a transposed immediately preceding matrix.

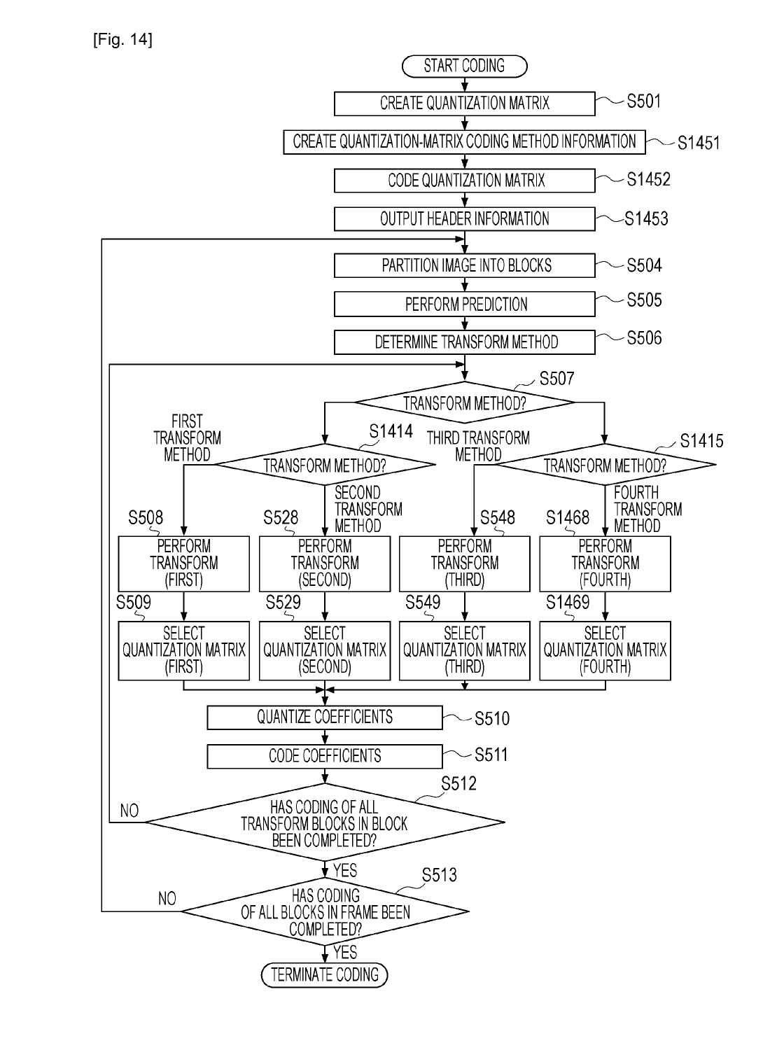

FIG. 14 is a flowchart of the image coding process of the image coding apparatus according to the fifth embodiment. In FIG. 14, the steps of performing the same functions as in the third embodiment of FIG. 10 are given the same reference numerals, and descriptions thereof will be omitted.

In step S1451, the coding-method creating section 851 determines a quantization-matrix coding method for use in the subsequent step S1452. In step S1452, the quantization-matrix coding section 809 codes the quantization-matrix coding method determined in step S1451 and codes the quantization matrices coded in step S501 in accordance with the method. In step S1453, header information including the quantization-matrix coding method information codes and the quantization-matrix code data is created.

In steps S507, S1414, and S1415, the image coding apparatus makes determinations based on the orthogonal transform method determined in step S506. If the orthogonal transform method is the first transform method, the process proceeds to S508, if the method is the second transform method, the process proceeds to S528, if the method is the third transform method, the process proceeds to S548, and if the method is the fourth transform method, the process proceeds to S1468.

In step S1468, the transform section 103 performs an orthogonal transform on the prediction error created in step S505 by using the fourth transform method to create an orthogonal transform coefficient. In step S1469, the quantization-matrix selecting section 107 selects the quantization matrix 1303 in FIG. 13D from the quantization matrices created in step S501 by using the orthogonal transform method created in step S506.

With the foregoing configuration and operation, in the case where the vertical processing and the horizontal processing of the orthogonal transform are transposed, a bit stream whose amount of codes is reduced can be created by using a transposed quantization matrix.

Although this embodiment has been described using an example in which quantization-matrix coding method information is coded for the individual quantization matrices, the present invention is not limited thereto. Coding of part or all of the quantization-matrix coding method information can be omitted. For example, provided that a quantization matrix corresponding to the first transform method in which the rows and columns are transposed is always used as a quantization matrix corresponding to the second transform method is always used, coding of quantization-matrix coding method information corresponding to the second transform method can be omitted.

### Sixth Embodiment

In a sixth embodiment of the present invention, the image decoding apparatus has the same configuration as that in the fourth embodiment of FIG. 9. However, it differs in the operations of the decoding-method decoding section 951 and the quantization-matrix decoding section 908. Accordingly, the operations of the other components are the same as those of the fourth embodiment, and descriptions thereof will be omitted. The image decoding operation of the image decoding apparatus will be described hereinbelow.

Referring to FIG. 9, the decoding-method creating section 951 receives the quantization-matrix coding information codes of the individual quantization matrices included in header information from the decoding and separating section 901, where the quantization-matrix coding method information is reproduced for each of the quantization matrices. The decoded quantization-matrix coding method information is input to the quantization-matrix decoding section 908.

Quantization-matrix code data subsequent to the quantization-matrix coding information codes is input to the quantization-matrix decoding section 908. The quantization-matrix decoding section 908 selects a quantization-matrix decoding method on the basis of the input quantization-matrix coding information and decodes the quantization-matrix code data to reproduce quantization matrices for use in the subsequent inverse quantization process.

In this embodiment, a first quantization matrix corresponding to the first transform method, a second quantization matrix corresponding to the second transform method, a third quantization matrix corresponding to the third transform method, and a fourth quantization matrix corresponding to the fourth transform method are decoded. In this embodiment, if the quantization-matrix coding method information is 0, the immediately preceding quantization matrix is used as it is, and information of the elements of the target quantization matrix is not decoded. On the other hand, if the quantization-matrix coding method information is 1, the difference values between the elements of the target quantization matrix and the immediately preceding elements are decoded. If the quantization-matrix coding method information is 2, a transposed quantization matrix in which the rows and columns are transposed from those of the immediately preceding quantization matrix is used. However, a combination of quantization-matrix coding method information and a quantization-matrix decoding method is not limited thereto.

Specifically, an example in which a quantization matrix corresponding to the first transform method is decoded and in which the quantization matrix is the quantization matrix 1300 shown in FIG. 13A will be described. In decoding of a quantization matrix corresponding to the subsequent second transform method, if the quantization-matrix coding method information is 0, the quantization matrix 1300 shown in FIG. 13A is used as it is. If the quantization-matrix coding method information is 1, the difference values of the elements are decoded to reproduce an independent quantization matrix and are used. If the quantization-matrix coding method information is 2, a transposed quantization matrix whose rows and columns are transposed from those of the quantization matrix 1300 shown in FIG. 13A, that is, the quantization matrix 1301 shown in FIG. 13B, is used. The thus-reproduced quantization matrices are output to the quantization-matrix storage section 309.

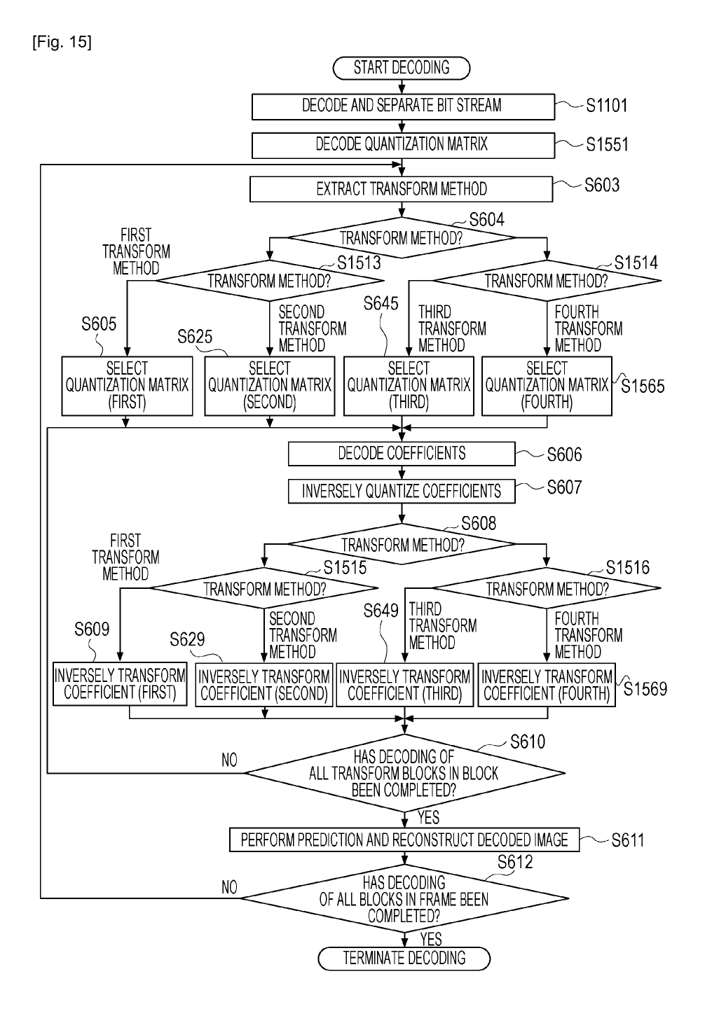

FIG. 15 is a flowchart of the image decoding process of the image decoding apparatus according to the sixth embodiment. The steps of performing the same functions as in the fourth embodiment of FIG. 11 are given the same reference numerals, and descriptions thereof will be omitted.

In step S1551, the decoding-method decoding section 951 decodes a quantization-matrix coding information code included in the header information to reproduce quantization-matrix coding method information. Furthermore, the quantization-matrix decoding section 908 selects a quantization-matrix decoding method on the basis of the quantization-matrix coding method information and decodes quantization-matrix code data subsequent to the quantization-matrix coding information code to reproduce a quantization matrix.

In steps S604, S1513, and S1514, a determination based on the orthogonal transform method information created in step S603 is performed. If the orthogonal transform method is the first transform method, the process proceeds to S605, if the method is the second transform method, the process proceeds to S625, if the method is the third transform method, the process proceeds to S645, and if the method is the fourth transform method, the process proceeds to S1565.

In step S1565, the quantization-matrix selecting section 307 selects a quantization matrix to be applied to the transform block on the basis of the orthogonal transform method information. Specifically, the quantization-matrix selecting section 307 selects the fourth quantization matrix because the extracted orthogonal transform method information is the fourth transform method.

In steps S608, S1515, and S1516, a determination based on the orthogonal transform method information created in step S603 is performed again. If the orthogonal transform method is the first transform method, the process proceeds to S609, and if the method is the second transform method, the process proceeds to S629, if the method is the third transform method, the process proceeds to S649, and if the method is the fourth transform method, the process proceeds to S1569.

In step S1569, the inverse transform section 304 performs an inverse orthogonal transform based on the fourth transform method on the orthogonal transform coefficient reproduced in step S607 to reproduce a prediction error.

With the foregoing configuration and operation, in the case where the vertical processing and the horizontal processing of the orthogonal transform are transposed, a bit stream whose amount of codes is reduced can be decoded by using a transposed quantization matrix, and thus a reproduced image can be acquired. This allows decoding of a bit stream in which the amount of codes generated by coding the quantization matrices is reduced.

### Seventh Embodiment

The foregoing embodiments have been described assuming that the processing units shown in FIGS. 1, 3, 8, and 9 are hardware. As an alternative, the processes performed by the processing units shown in FIGS. 1, 3, 8, and 9 may be achieved using a computer program.

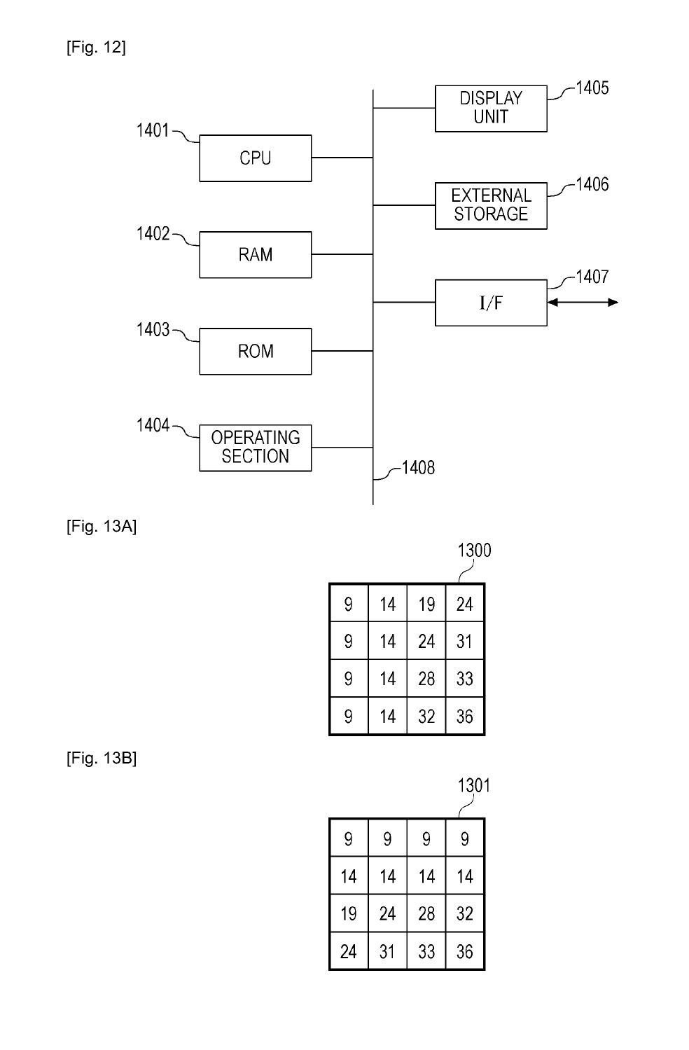

FIG. 12 is a block diagram showing an example of the configuration of computer hardware that can be applied to the image display apparatuses according to the above embodiments.

A CPU 1401 controls the entire computer by using a computer program and data stored in a RAM 1402 or a ROM 1403 and implements the foregoing processes to be performed by the image processing apparatuses according to the foregoing embodiments. That is, the CPU 1401 functions as the processing units shown in FIGS. 1, 3, 8, and 9.

The RAM 1402 has an area for temporarily storing a computer program and data loaded from an external storage 1406 and data acquired from the outside via an interface (I/F) 1409. The RAM 1402 also has a work area that the CPU 1401 uses when implementing various processes. That is, the RAM 1402 can be used as a frame memory or can provide other various areas as appropriate.

The ROM 1403 stores set data, a boot program, and so on of the computer. An operating section 1404 includes a keyboard and a mouse, which the user of the computer operates to input various instructions to the CPU 1401. A display unit 1405 displays the result of processing by the CPU 1401. An example of the display unit 1405 is a display, such as a liquid crystal display.

The external storage 1406 is a mass information storage typified by a hard disk drive. The external storage 1406 stores an operating system (OS) and a computer program for causing the CPU 1401 to implement the functions of the components shown in FIGS. 1, 3, 8, and 9. The external storage 1406 may also store image data to be processed.

The computer program and data stored in the external storage 1406 are loaded on the RAM 1402 as appropriate under the control of the CPU 1401 and are to be processed by the CPU 1401. An I/F 1407 can connect to a network, such as a LAN and the Internet, and other devices, such as a projector and a display. The computer can acquire or send various information via the I/F 1407. Reference numeral 1408 denotes a bus that connects the foregoing components.

The operations of the above components, which have been described in the foregoing flowcharts, are centrally controlled by the CPU 1401.

### Other Embodiments

The present invention can also be achieved by supplying a storage medium that stores computer program code for implementing the foregoing functions to a system and by reading and implementing the computer program code by the system. In this case, the computer program code itself read from the storage medium implements the functions of the foregoing embodiments, and the storage medium that stores the computer program code constitutes the present invention. The present invention also includes a case where an operating system (OS) or the like operating on the computer implements part or whole of actual processes on the basis of the instructions of the program code, and the foregoing functions are implemented by the processes.

The present invention may also be achieved as follows: Computer program code read from a storage medium is written to a feature expansion card inserted into the computer or a memory provided in a feature expansion unit connected to the computer. The feature expansion card or a CPU provided in the feature expansion unit performs part or the whole of the actual processes, so that the foregoing functions are implemented.

In the case where the present invention is applied to the storage medium, the storage medium stores computer program code corresponding to the flowcharts described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-155011, filed Jul. 13, 2011 and No. 2012-103806, filed Apr. 27, 2012, which are hereby incorporated by reference herein in their entirety.

1. An image coding apparatus comprising:
an image partitioning unit configured to partition an input image into a plurality of blocks;
a prediction unit configured to perform a prediction on the blocks partitioned by the image partitioning unit from a coded block to create a prediction error;
a transform unit configured to determine an orthogonal transform method from a plurality of orthogonal transform methods and to perform the determined orthogonal transform on the prediction error created by the prediction unit to create a transform coefficient;
a quantization-matrix selecting unit configured to select a quantization matrix on the basis of the orthogonal transform method determined by the transform unit;
a quantization unit configured to quantize the transform coefficient created by the transform unit by using the quantization matrix selected by the quantization-matrix selecting unit to create a quantization coefficient; and
a coefficient coding unit configured to code the quantization coefficient quantized by the quantization unit.

2. The image coding apparatus according to claim 1, further comprising:
a quantization-matrix creation unit configured to create a quantization matrix for use in quantizing the transform coefficient;
a quantization-matrix coding unit configured to code the quantization matrix; and
an integral coding unit configured to integrate the quantization matrix coded by the quantization-matrix coding unit and the quantization coefficient coded by the coefficient coding unit.

3. The image coding apparatus according to claim 2, wherein the quantization-matrix creation unit creates a plurality of quantization matrices; and
the quantization-matrix coding unit codes the difference between a first quantization matrix and a second quantization matrix and the subsequent quantization matrices of the plurality of quantization matrices.

4. The image coding apparatus according to claim 2, wherein
the quantization-matrix creation unit creates a plurality of quantization matrices, and the quantization-matrix coding unit uses a corrected first quantization matrix of the plurality of quantization matrices as a second quantization matrix and the subsequent quantization matrices.

5. The image coding apparatus according to claim 4, wherein the quantization-matrix coding unit corrects the first quantization matrix by transposing the first quantization matrix.

6. The image coding apparatus according to claim 1, wherein the transform unit determines an orthogonal transform method depending on the direction of intra-prediction.

7. An image decoding apparatus comprising:
a decoding unit configured to decode header information of an input bit stream and to separate a necessary code;
a determination unit configured to determine an inverse orthogonal transform method from the information decoded by the decoding unit;
a coefficient decoding unit configured to decode a quantization coefficient from the information decoded by the decoding unit;
a quantization-matrix decoding unit configured to decode a quantization matrix for use in inversely quantizing the quantization coefficient decoded by the coefficient decoding unit;
a quantization-matrix selecting unit configured to select a quantization matrix on the basis of the inverse orthogonal transform method determined by the determination unit;
an inverse quantization unit configured to inversely quantize the quantization coefficient decoded by the coefficient decoding unit by using the quantization matrix selected by the quantization-matrix selecting unit to create a transform coefficient; and
an inverse orthogonal transform unit configured to inversely orthogonally transform the transform coefficient created by the inverse quantization unit on the basis of the inverse orthogonal transform method determined by the determination unit to create a prediction error.

8. An image coding method of an image coding apparatus, the method comprising the steps of:
partitioning an input image into a plurality of blocks;
performing a prediction on the partitioned blocks from a coded block to create a prediction error;
determining an orthogonal transform method from a plurality of orthogonal transform methods and performing the determined orthogonal transform on the created prediction error to create a transform coefficient;
selecting a quantization matrix on the basis of the determined orthogonal transform method;
quantizing the created transform coefficient by using the selected quantization matrix to create a quantization coefficient; and
coding the quantized quantization coefficient.

9. An image decoding method of an image decoding apparatus, the method comprising the steps of:
decoding header information of an input bit stream and separating a necessary code;
determining an inverse orthogonal transform method from the decoded information;
decoding a quantization coefficient from the decoded information;
decoding a quantization matrix for use in inversely quantizing the decoded quantization coefficient;
selecting a quantization matrix on the basis of the determined inverse orthogonal transform method;
inversely quantizing the decoded quantization coefficient by using the selected quantization matrix to create a transform coefficient; and
inversely orthogonally transform the created transform coefficient on the basis of the determined inverse orthogonal transform method to create a prediction error.

10. A program that, when read and implemented by a computer, causes the computer to function as the image coding apparatus according to claim 1.

11. A program that, when read and implemented by a computer, causes the computer to function as the image decoding apparatus according to claim 7.
